(19) United States
(12) Patent Application Publication
(10) Pub. No.: US 2004/0031204 A1
(43) Pub. Date: Feb. 19, 2004

(54) Door mounting assembly and method

(76) Inventor: Ronald Thompson, Fullerton, CA (US)

Correspondence Address: ROBERT J. SCHAAP, Suite 188, 21241 Ventura Boulevard, Woodland Hills, CA, 91364, US

(21) Appl. No.: 10/219,803

(22) Filed: Aug. 14, 2002

(51) Int. Cl. E06B 3/00

(52) U.S. Cl. 49/501

(57) ABSTRACT

A door mounting system for mounting a hingedly swingable door to an existing door frame structure. The assembly comprises a plurality of hinge locators which can be used for mounting to the door, in essentially proper position, with respect to the hinge mortices on the door jamb. Mounting strips, such as so-called “trim strips”, are also mounted on the door with respect to the location of the hinge locators and hinges. A single trimming strip having a hinge receiving recess is also provided. This assembly allows for the very easy and relatively simple mounting of a door in a hinged position with respect to a door jamb.

### BACKGROUND OF THE INVENTION

1. Field of the Invention

This invention relates in general to certain new and useful improvements in an assembly for mounting a door in a hinged position with respect to an existing door jamb, and a method of use therefor, and more particularly, to an assembly which relies upon hinge locators and trim strips for properly mounting the door with respect to an existing door jamb, relatively simply, with a minimal amount of labor, and which is nevertheless functionally accurate and renders a highly pleasing door mount.

2. Brief Description of Related Art

In both residential and commercial, as well as industrial, buildings, from time to time, the existing doors in that building become worn, damaged or unsightly, and may therefore require replacement. The same holds true in the case of water damage to an existing door. Generally, and although the door jamb, including the frame of the door and the jamb strips mounted on the door, may remain, it is necessary to remove the existing door and remount a new door therefor.

When an existing door is removed, the hinge pins which hingedly mount the door to the jamb, can be pulled out of the hinge plates, and allow separation of the pair of hinge plates constituting a hinge. However, in order to mount a new door, it is necessary to remount the hinge plates removed from the existing door onto the new door. Moreover, the hinge plates must be mounted in a proper position with respect to the hinge plates presently existing on the jamb, so that the hinge pins can be again inserted in the hinge pin openings of the respective plates, for rehanging a new door on the existing jamb.

In order to remount the hinge plates removed from the former door to a new door, it is typically necessary to form hinge mortices in the new door, so as to enable positioning of the hinge in a manner where the two plates of the hinge can overlap one another in abutting position, when the door is shifted to a closed position in the jamb. If the hinge mortices formed in the door are not precisely positioned with respect to the hinge mounted on the jamb, then the door may not fit properly within the door opening. Moreover, if the hinge is recessed too deeply in a mortice formed in the door, then the door will not properly close with respect to the jamb. In addition, if the mortice is not sufficiently deep so that the hinge plate is flush with the outre edge of the door receiving the hinge, then a space or gap will exist between the door and the jamb when the door is shifted to a closed position.

Because of the difficulty in properly mounting a door with respect to a jamb, generally a substantial amount of care must be taken in forming the hinge mortices in the door and the mortices must be formed in the door jamb in such manner to ensure that they are a proper depth, and the mortices must be properly positioned in order to receive hinge plates of the door. This typically requires a fair amount of manual labor, and special tooling needed for forming the hinge mortices in the jamb and in the door, as well as a fair amount of skill in the mounting of hinged doors to door jambs. All of these requirements necessitate a higher cost in the actual mounting of the door to a door jamb.

In many cases, and in the mounting of a door to an existing door jamb, a power router can be used to form the mortice. Otherwise, chiseling may be used. The attachments for a power router include a special jig needed for positioning the mortices in the door edge, and with respect to mortices in the jamb. The special jig is arranged to allow for transverse adjustment of the hinge mortice. This transverse adjustment allows for an exact fit between the door and the jamb, when the door is properly mounted to the jamb. If a transverse adjustment is improper, the door can bind in the closed position, or there may be a gap between the door and the jamb, as aforesaid.

So-called “pre-hung” doors are commercially available for mounting in a doorway. However, in order to use a pre-hung door, it would be necessary to remove the existing door jamb structure, and remount the jamb structure provided with the pre-hung door. Due to the fact that the remounting of a new jamb structure could entail more labor, and for that matter, more cost in the mounting of the jamb, it may be impractical to remove the existing door jamb structure in order to mount a new door jamb structure, only for the purposes of remounting a new door in an existing door opening.

Today, there is no effective technique or system known for easily and effectively mounting a hinged door to an existing door jamb, with a minimal amount of skilled labor. It would therefore be desirable to provide both an assembly and a method which allows for hinged mounting of a door to an existing door jamb structure, relatively simply, and with a minimal amount of skilled labor, and which provides for the mounting of the door accurately so that the hinge arrangement is at least aesthetically pleasing.

### OBJECTS OF THE INVENTION

It is, therefore, one of the primary objects of the present invention to provide a door mounting assembly and a method for mounting of a door to an existing door jamb, which allows a door to be hingedly mounted on a door jamb with a minimal amount of manual attention.

It is another object of the present invention to provide an assembly of the type stated, which allows for hinge locators to be mounted on a door and, along with trim strips, to be mounted on an edge of the door adjacent to the hinge locators for easily and properly mounting a door to a door jamb structure.

It is a further object of the present invention to provide a door mounting assembly of the type stated, which can be used for the mounting of a new door to an existing door jamb, or for that matter, for the mounting of a new door to a new door jamb structure, and which reduces the amount of manual labor time which would normally be employed using prior art techniques for hingedly mounting a door to a door jamb.

It is an additional object of the present invention to provide a door mounting assembly, for hingedly mounting a door to a door jamb, relatively efficiently, and with a minimal amount of skilled labor required for the hanging of a door, but which is highly effective in its operation, and which assembly is available at a relatively low cost.

It is another salient object of the present invention to provide a method of hingedly mounting a door to a door jamb, in such manner that the edge of the door is properly spaced with respect to the edge of the jamb, when the hinges are mounted both to the jamb and the door, to allow for proper closing of the door.

With the above and other objects in view, my invention resides in the novel features of form, construction, arrangement and combination of parts presently described and pointed out in the claims.

### BRIEF SUMMARY OF THE INVENTION

Broadly, the present invention relates to the mounting of a door to a door jamb, where hinges are mounted to an edge of the door and to the door jamb, allowing a swinging movement of the door with respect to that jamb. Although the invention is effective for the hanging of a new door with respect to a new door jamb in a door opening, the invention is particularly effective for the hanging of a new door with respect to an existing door jamb. Consequently, and although the invention may be described in terms of hanging of a new door to an existing door jamb structure, the invention is equally applicable in both new door jamb assembly construction, as well as the hanging of a new door to an existing door jamb construction.

In the hanging of any door, hinges comprised of a pair of hinge plates and a hinge pin, are employed. In these hinges, one of the hinge plates is typically mounted in an edge of the door and the opposite hinge plate is mounted on the door jamb. Each of these plates are provided with outwardly struck arcuately shaped hinge pin brackets, or so-called “loops”, to receive a hinge pin. Although the hinges may vary in size and shape, and even in the aesthetic appearance, essentially all door mounting hinges are made with this standard hinge construction, comprised of the hinge plates and the hinge pin.

In existing door structures, where the door is hingedly mounted to the jamb, when the door is shifted to a closed position, the hinge plate mounted on an edge of the door will generally abut against a cooperating hinge plate mounted on the jamb. In order to allow for proper closing of the door, however, it is necessary to form a groove or mortice in the jamb to receive one of the hinge plates, and a corresponding groove or mortice properly positioned in the edge of the door, to receive the other of the hinge plates, so that the two hinge plates will lie together in meeting engagement when the door is shifted to the closed position.

Generally, a fair amount of labor, and moreover, skilled labor, is involved in the notching of the edge of the door and the door jamb, in order to receive the hinge plates. When the mortices are properly formed, the hinge plates will merely abut against one another or be very closely spaced apart from one another when the door is shifted to the closed position. In fact, this proper mounting of the hinges is quite critical in order to ensure that the door does not bind when it is moved to a closed position, and also allows for tight closing of the door in the door jamb, when in the closed position.

When an existing door is removed from a door jamb, or when a new door is being mounted to a new door jamb, it is necessary to remount the hinge plates on the new door. Usually, a plurality of vertically arranged and spaced apart hinges are employed for hanging a door on a door jamb. In order to properly mount the existing hinge plates, if they have been removed from an existing door, it is no longer necessary to carefully notch mortices in the door to receive the hinge plates, which may have been removed from an existing door. The present invention provides an alternative which is relatively easy to employ, and allows for rapid hanging of a door to a door jamb.

In accordance with the present invention, there are provided hinge locators with a separate hinge locator for each hinge arrangement. Moreover, trim strips are also provided for use with the edge of the door receiving the hinges. Each hinge is provided with a new hinge locator. The hinge locator may be mounted onto an edge of the door, which would be swingable adjacent to the door jamb. Each hinge locator is provided with a recess formed therein, sized to receive a standard hinge plate. In this embodiment, the hinge locator is thereby provided with a flat plate having on one surface thereof a continuous upstanding projection formed of three sides, allowing the three sides and thereby forming a recess.

In another embodiment of the invention, the hinge locator may be provided in the form of a three sided frame, that is, with an elongate arm adapted to extend longitudinally on a door and a pair of transversely struck relatively short arms. Moreover, and in each embodiment, the hinge locator could be provided with small openings in which to visually view markings on a door for proper location thereof. In either case, the recess or the opening is of sufficient width so that the hinge plate can be shifted properly to allow the hinge pin brackets of one plate to mate with the hinge pin brackets of the opposite and mating hinge plate. In any event, each hinge of the door has its hinge plate mounted on or within a hinge locator, and that hinge locator is, in turn, mounted to the edge of the door.

In addition to the hinge locators, trim strips are mounted onto the edge of the door which receives the hinge plates, and in a position between each of the hinge locators. The trim strips have a thickness equivalent to the thickness of the hinge locators, with the hinge plate mounted therein, so that the hinge becomes flush with the outer surface of the edge of the door arrangement. Consequently, there is a guaranteed fit of the hinge plate in a groove formed at that edge of the door. Moreover, there is no need to precisely form grooves in the edge of the door, which will allow for proper mating of the hinge plate when mounted to the edge of the door. This new assembly will eliminate essentially all of that costly labor time previously involved in the notching of the door and the hanging of the hinges in the notches in that door.

In substance, the trim strips which have the same thickness as the hinge locators with the hinges thereon, provide a flush surface on the door, and which thereby allows for a hinged mounting to a door jamb. The trim strips are arranged to abut against the hinge locators and are positioned to be flush with the front and back faces of the door. In this way, the hinge locators, along with the hinges thereon, and the trim strips, appear to be a part of the door.

The present invention thereby provides a unique and novel door mounting system which satisfies and fulfills all of the objects and advantages, as well as other advantages, which have been sought and which will become more fully apparent from a consideration of one of the forms which is illustrated and described in the attached drawings and the following detailed description. However, it should be understood that this detailed description and the attached drawings are set forth in order to convey the general principles of the invention, but should not be taken in a limiting sense.

### BRIEF DESCRIPTION OF THE DRAWINGS

Having thus described the invention in general terms, reference will now be made to the accompanying drawings in which:

FIG. 1 is an exploded perspective view showing a door along with a hinged door mount assembly used for securing a door to a door jamb, in accordance with the present invention;

FIG. 2 is an enlarged exploded perspective view, taken from a different angle with respect to FIG. 1, and showing portions of the assembly forming part of the present invention;

FIG. 3 is a top plan view showing the mounting of a hinge to a door, in accordance with the present invention;

FIG. 4 is a perspective view of a hinge locator forming part of the assembly of the invention;

FIG. 5 is a fragmentary perspective view showing a portion of a trim strip forming part of the assembly of the present invention;

FIG. 6 is a perspective view of a modified form of hinge locator, forming part of the hinge door mount assembly of the invention;

FIG. 7 is a fragmentary exploded perspective view, somewhat similar to FIG. 2, and showing the assembly of the invention with a modified form of hinge locator;

FIG. 8 is a top plan view, somewhat similar to FIG. 3, and showing the mounting of a hinge to a door using a modified hinge locator of the invention, and also in accordance with the present invention; and

FIG. 9 is a fragmentary exploded perspective view showing a further modified form of hinged door mounting system assembly in accordance with the present invention.

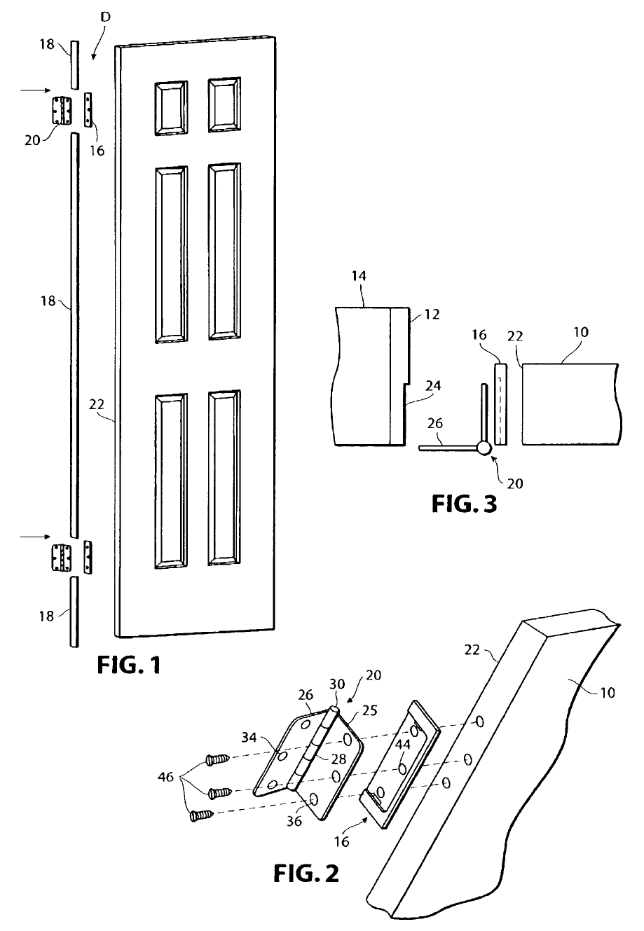

### DETAILED DESCRIPTION OF A PRACTICAL EMBODIMENT

Referring now in more detail and by reference characters to the drawings which illustrate practical embodiments of the present invention, D illustrates a door mounting assembly in accordance with the present invention, for mounting a conventional door 10 to a door jamb. By reference to FIG. 3, it can be observed that the door 10 is mounted to a door jamb 12, forming part of a wall structure 14.

The assembly of the invention, in the embodiment as shown, comprises a pair of hinge locators 16, along with trim strips 18. In this way, conventional hinges 20 can be secured to a transverse end 22 of the door.

In accordance with the invention, the door jamb 12 is provided with a notch 24, or so-called “mortices”, for receiving a hinge plate forming part of the hinge 20. It can be observed, by reference to FIGS. 2 and 3, that each hinge 20 is comprised of a first hinge plate 25, which is adapted for securement to the transverse end 22 of the door 10, and a second hinge plate 26, which is adapted for securement to a jamb, such as the jamb 12. These two hinge plates 25 and 26 are connected through a hinge 28 by means of a hinge pin 30. This construction of the hinge 20 is generally conventional, and therefore neither illustrated nor described in any further detail herein.

However, by further reference to FIG. 3, it can be observed that the hinge plate 26, is adapted to fit within the notch 24. In this way, the hinge 20 can be secured to the door jamb 12 by means of screws (not shown). For this purpose, the hinge plate 26 is provided with fastener receiving openings 34. In like manner, the hinge plate 25 is provided with fastener receiving openings, such as screw openings 36, for securement to a door.

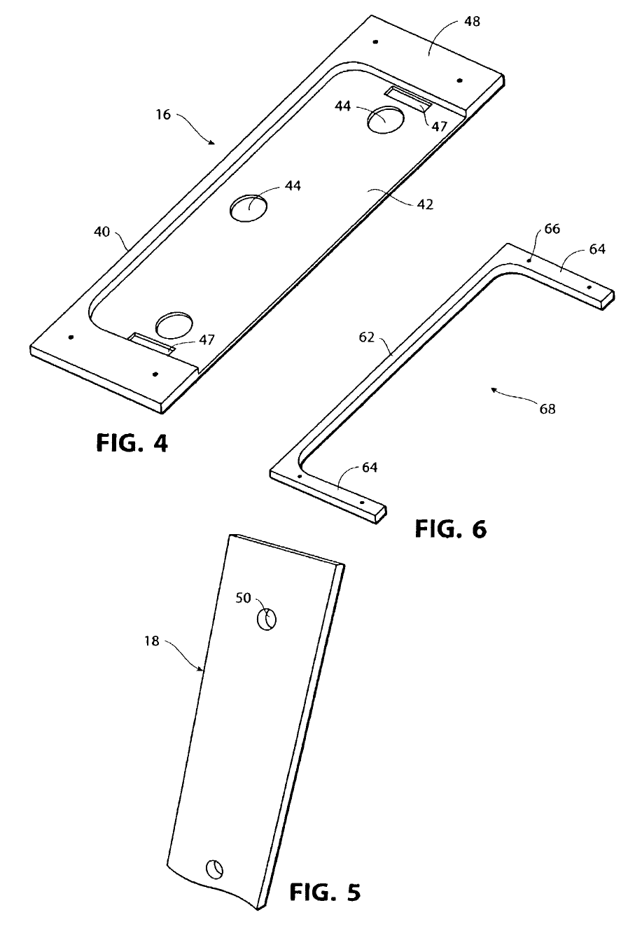

In accordance with the invention, it is now possible to avoid the need for forming notches or mortices in the transverse end 22 of the door, in the same manner that mortices 24 were formed in the door jamb 12. In this case, the assembly D of the invention comprises the hinge locator 16. Each hinge locator 16, which may be used, is more fully illustrated in FIG. 4 of the drawings, and comprises a plate or frame 40, having a recess or relief 42, sized to receive a hinge plate, such as the hinge plate 25. Moreover, the relieved area 42 of the hinge frame 40 may be provided with screw receiving apertures 44, for receiving conventional wood screws 46, the latter of which are more fully illustrated in FIG. 2 of the drawings. Moreover, each relieved area 42 is surrounded on three sides by a ridge 48.

In accordance with this construction, a hinge plate 25, for example, is inserted in the recessed area 42 and screws, such as wood screws 46, if used, are inserted through aligned apertures 36 and 44, in order to secure the hinge plate and the hinge mount directly to the transverse end 22 of the door. Moreover, the recessed or relief area 42 has a depth equal to the thickness of the hinge plate 25. In this way, when the hinge plate and hinge mount are secured to the transverse end of the door, they will together be flush with one another.

Each hinge locator 16 is also provided with a small viewing opening 47, as best shown in FIG. 4. In this way, it is possible to visually align the locator with a mark placed on a door or door jamb, to ensure proper positioning of the locator.

After securement of the hinges to hinge locators, such as the hinge locators 16, trim strips, such as the trim strip 18, which is merely formed of wood, may have preformed holes 50, for receiving screws in order to secure the strips 18 to the transverse end 22 of the door. Moreover, the trim strips 18 each have a thickness equal to the ridge 48 on the hinge locator 16. In this way, the trim strips and hinge mount and hinge plate are all flush at the surface of the trim strips. Thus, when the door is mounted to the jamb 12, there will be a proper fit of the door with respect to the door jamb.

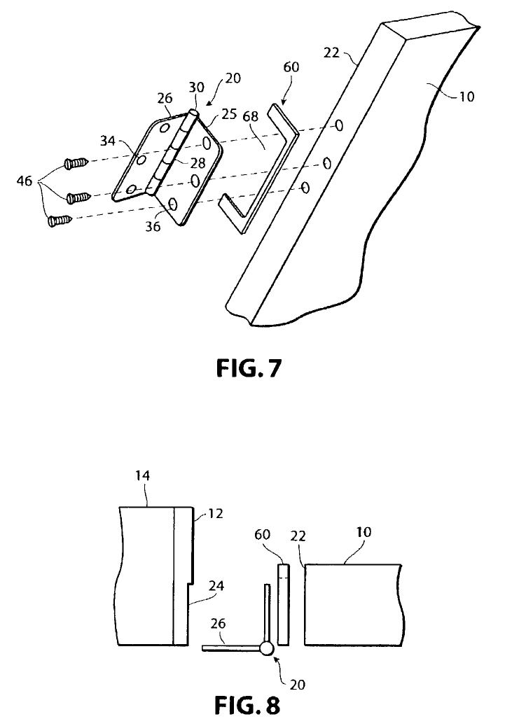

FIGS. 6, 7 and 8 illustrate the assembly of the present invention, with a modified form of hinge locator 60, which differs from the hinge locator 16, in that it comprises a three sided frame, as best illustrated in FIGS. 6 and 7. In this case, the frame is comprised of a longitudinal strip 62 and a pair of integrally formed transversely extending strips 64. Each of the strips 64 are similarly provided with openings, such as fastener receiving openings 66. In accordance with this construction, the three sided frame of the modified hinge locator forms an opening 68, which is sized to receive a hinge plate. Moreover, the hinge frame has a thickness 70 which is specifically sized to receive a thickness of a hinge plate 25.

In accordance with this construction, the hinge locator 60 is used in essentially the same manner as the hinge locator 16. FIG. 7 shows the use of the hinge locator 60, in place of the hinge locator 16. It can be observed that in this case the hinge plate fits snugly within the opening 68.

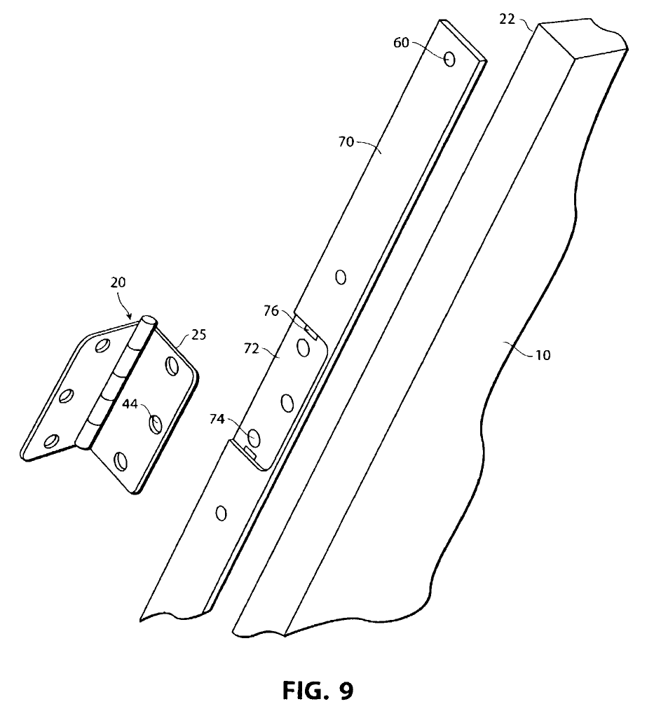

FIG. 9 illustrates a further modified embodiment of a door mounting assembly for hingedly mounting a door in accordance with the invention. The modified door mounting assembly comprises an elongate mounting strip 70, which is adapted for attachment to the transverse end 22 of a door 10. The mounting strip has a plurality of longitudinally spaced apart recesses 72, forming recessed areas. Each recessed area 72 is sized and shaped to receive a hinge plate of a hinge, such as the hinge plate 25, forming part of the hinge 20. Moreover, the recess 72 has a depth sufficient to enable the hinge plate 25 to be flush with the outer face of the mounting strip 70. For this purpose, the recessed area 72 could be provided with fastener receiving openings 74, alignable with the screw receiving openings 44. In this way, screws can be inserted through the aligned openings 44 and 74, for securing the hinges directly to the transverse end 22 of the door 10.

Each of the recessed areas 72 would similarly be provided with viewing windows 76, as also best shown in FIG. 9. These viewing windows would serve the same function as the viewing windows 47, in the previously described embodiments of the locator.

Each mounting strip 70 may be formed in lengths which are standard for individual doors. Otherwise, they may be formed in lengths which are in excess of most doors, so that the user can cut one or both of the ends off in order to conform to the overall height of the door. Moreover, for purposes of mounting the hinge strips individually to the door, additional mounting openings 60 are provided.

Each of the mounting strips would preferably be formed of the same material as the door 10. Thus, if the door then were formed of a wood material, then the mounting strips 70 would similarly be formed of that same material. Thus, the mounting strips could be made to closely match the surface of the door.

The hinge locators 16 can be formed of any suitable material and may easily and conveniently be formed of injection molded or other molded plastic materials. However, they can be formed of metal, or for that matter, they can also be formed of wood.

Notwithstanding the materials of construction, it can be observed that both of the assemblies forming part of the present invention are effective in allowing a door to be hingedly mounted to a door jamb, with a minimal amount of manual labor involved therefor. Thus, this invention allows the relatively unskilled person to conveniently and easily mount a door with the same degree of aesthetic appearance to the mounting, which would be provided as if hung by a skilled door hanger.

Thus, there has been illustrated and described a unique and novel door mounting assembly and method and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A door mounting assembly for hingedly mounting a door to a jamb of a door frame for hinged movement thereon, said door mounting assembly comprising:
a) a locating member adapted for securement to a transverse end of a door, and having a pre-formed hinge plate relief sized to receive a hinge plate of a door hinge, and which door hinge has a cooperating hinge plate which remains available for securement to a door jamb thereby providing for one hinge plate to be mounted to the jamb and another cooperating hinge plate of that door hinge to be mounted to the door in conjunction with the locating member; and
b) a trimming strip associated with said locating member for mounting on the transverse end of the door and extending substantially over the full transverse end of the door, and which thereby avoids the necessity of forming a notch in the transverse end of the door.

2. The door mounting assembly for hingedly mounting a door to a jamb of claim 1 further characterized in that said locating member having a pre-formed hinge plate relief is a hinge locator comprised of a mounting plate having a relief to receive said hinge plate so that the hinge plate is flush with the remaining surface of the hinge locator.

3. The door mounting assembly for hingedly mounting a door to a jamb of claim 2 further characterized in that the trimming strip has an outer surface flush with the hinge locator and the hinge plate so that the entire assembly is flush on and forms a contiguous flat surface on transverse end of the door.

4. The door mounting assembly for hingedly mounting a door to a jamb of claim 1 further characterized in that said mounting member has a pre-formed hinge plate relief so a trimming strip which is adapted to extend along the transverse end of the door substantially for the full length of the door from top to bottom thereof except for the portion having the mounting member thereon.

5. The door mounting assembly for hingedly mounting a door to a jamb of claim 2 further characterized in that a plurality of said hinge locators are provided with said assembly and are adapted for vertically spaced apart securement to the door in general alignment with mortices in the door jamb to receive a cooperating hinge plate.

6. The door mounting assembly for hingedly mounting a door to a jamb of claim 5 further characterized in that a plurality of trimming strips are provided for securement to the transverse end of the door in those regions which are not covered by the hinge locators.

7. The door mounting assembly for hingedly mounting a door to a jamb of claim 2 further characterized in that said locator is a plate member having an upstanding three sided rim surrounding a portion of and on three sides of said plate and having a thickness sized to snugly receive a hinge plate.

8. The door mounting assembly for hingedly mounting a door to a jamb of claim 2 further characterized in that said locator is a three sided frame having an opening with a thickness sized to snugly receive a hinge plate.

9. The door mounting assembly for hingedly mounting a door to a jamb of claim 2 further characterized in that each locator has a viewing window to enable alignment of the locator with a pre-marked index enabling alignment of the locator on the door or jamb.

10. An improved door mounting system for hingedly mounting a door to a door jamb without notching an end of the door, said assembly comprising:
a) means having a pre-formed door mounting hinge plate receiving notch for receiving a hinge plate in the notch and for attachment of the hinge plate and said means to a transverse end of the door and which means presents a flush contiguous new transverse end surface on the door, such that a cooperating jamb mounting hinge plate can be mounted to a door jamb thereby allowing the door to hingedly rotate through a hinge pin connected to said hinge plates.

11. A door mounting system for hingedly mounting a door of claim 10 further characterized in that the means for mounting the door comprises a plurality of hinge locators which are adapted for vertically spaced apart mounting on the door and to receive a door mounting hinge plate of a hinge and with the cooperating jamb mounting hinge plate being mounted to a door jamb.

12. The door mounting system of claim 11 further characterized that said system comprises a plurality of trimming strips which are capable of being mounted to the transverse end of the door in the regions of the transverse end not receiving the hinge locators so that there is a flush and contiguous transverse end surface.

13. The door mounting system of claim 10 further characterized in that said hinge locators have a plate with a relief surrounded on three sides of that plate with a ridge such that a hinge plate sits within said relief and is surrounded by said ridge.

14. A method for hingedly mounting a door to a door jamb of a door frame for hinged movement thereon, said method comprising:
a) mounting a plurality of hinge locators to a transverse end of a door;
b) simultaneously with the mounting of the hinge locators mounting a hinge plate of a hinge within a recessed portion of the hinge locator; and
c) securing a trim strip to the transverse end of the door not receiving the hinge mount.

15. The method of claim 14 further characterized in that the method comprises mounting trim strips on the transverse end of the door for the full transverse dimension of the door except for the regions covered by the hinge locators.

16. The method of claim 14 further characterized in that the method comprises connecting the hinge plate and the cooperating hinge plate with a hinge pin allowing swingable movement of the door on the door jamb.

17. The method of claim 14 further characterized in that the method comprises viewing a pre-marked index on a door or jamb enabling the proper alignment of the hinge locator with respect to a door or jamb.

18. The method of claim 14 further characterized in that the method comprises first securing a hinge locator to a transverse edge of the door and then thereafter securing a hinge on the door to a relief in the hinge locator.
